(19) United States
(12) Patent Application Publication
(10) Pub. No.: US 2025/0322564 A1
(43) Pub. Date: Oct. 16, 2025

(54) METHOD, SYSTEM AND/OR COMPUTER READABLE MEDIUM FOR MITIGATING ATTENUATION CORRECTION ARTIFACT IN PET DATA

(71) Applicant: GE Precision Healthcare LLC, Waukesha, WI (US)

(72) Inventors: Abolfazl Mehranian, Chalfont Saint Giles (GB); Scott David Wollenweber, Waukesha, WI (US); Kuan-Hao Su, Brookfield, WI (US); Robert Johnsen, Pewaukee, WI (US); Floribertus HEUKENSFELDT JANSEN, Ballston Lake, NY (US)

(73) Assignee: GE Precision Healthcare LLC, Waukesha, WI (US)

(21) Appl. No.: 18/631,817

(22) Filed: Apr. 10, 2024

(51) Int. Cl. G06T 11/00; G06T 7/00

(52) U.S. Cl. CPC G06T 11/005; G06T 7/0012; G06T 11/006; G06T 11/008; G06T 2207/10081; G06T 2207/10104; G06T 2207/20081; G06T 2207/20084; G06T 2207/20092; G06T 2207/30168; G06T 2211/441; G06T 2211/452

(57) ABSTRACT

A system includes an attenuation corrector configured to generate Computed Tomography-(CT-) based attenuation correction data from CT image data, a Positron Emission Tomography (PET) reconstructor configured to reconstruct first PET image data based on PET projection data and the CT-based attenuation correction data, an attenuation correction artifact mitigator configured to analyze the first PET image data for a presence of attenuation correction artifact, an inference engine configured to predict attenuation correction data based on non-attenuation corrected PET image data in response to the presence of attenuation correction artifact in the first PET image data, and an attenuation correction data updater configured to generate modified attenuation correction data based on the CT-based attenuation correction data and the predicted attenuation correction data. The PET reconstructor is further configured to reconstruct second PET image data based on the PET projection data and the modified attenuation correction data.

### FIELD

The following generally relates to Positron Emission Tomography (PET) and more particularly to mitigating attenuation correction artifact in PET data.

### BACKGROUND

Positron Emission Tomography (PET) is a functional imaging modality that utilizes a radiopharmaceutical with a tissue targeted radionuclide (i.e., a radiotracer) to visualize and/or measure functional processes such as metabolism, blood flow, absorption, etc. Prior to a PET scan, a radiopharmaceutical is administered to a patient. As the radionuclide accumulates within organs, vessels, or the like, the radionuclide undergoes positron emission decay and emits a positron. When the positron collides with an electron in the surrounding tissue, both the positron and the electron are annihilated and converted into a pair of photons, or gamma rays, each having an energy of 511 keV.

The two photons are directed in substantially opposite directions along a line of response (LOR) and are coincidently detected when they reach respective detectors positioned across from each other on a detector ring assembly, approximately one hundred and eighty degrees apart. When the photons impinge upon scintillation crystals of the detectors, a scintillation event (e.g., flash of light) is produced for each event, and detectors detect the scintillation events and produce electrical signals indicative thereof. The electrical signals are processed to generate PET data, which provides a distribution of the radiopharmaceutical in the patient.

The processing of the electrical signals to generate the PET data includes attenuation correction. As the two photons travel along the LOR, they traverse tissue such as bone, muscle, soft tissue, etc., that attenuates the photons, resulting in a reduction in the detected signal. Attenuation correction compensates for the reduction caused by the tissue attenuation, providing PET data that includes quantitative information about radiotracer distribution, which can be employed to assess metabolic activity, aiding in disease diagnosis, staging, and treatment planning. Without attenuation correction, generally, the PET data would be distorted, affecting lesion detection and quantification.

Attenuation correction approaches have included Computed Tomography (CT). For these, CT image data is used to calculate attenuation data, e.g., an attenuation coefficient (μ-) map. However, such attenuation data has introduced artifact into the PET projection data, e.g., due to tissue displacement between the PET and CT acquisitions from respiratory, cardiac, etc. phase mismatch, gross patient motion, etc. For example, respiratory phase mismatch results in under-correction or over-correction of attenuation at the bottom of the lungs. Under-correction artifact has manifested as white and photopenic areas referred to as “banana” artifact. Such data is not well-suited for quantitative measurements.

Approaches for mitigating such attenuation correction artifact include emission-based estimation of attenuation data, deep learning-(DL-) based methods that generate attenuation data from non-attenuated corrected (NAC) PET projection data or direct conversion of NAC PET image data into a fully corrected PET image data, and atlas-based registration methods. Unfortunately, emission-based estimation approaches are time-consuming and are not well-suited for non-Time of Flight (ToF) capable scanners, DL-based approaches are susceptible to produce new artifacts in the attenuation data, and atlas-based approaches are not patient specific and can be time consuming to generate.

In view of at least the foregoing, there is an unresolved need for an improved approach to mitigate attenuation correction artifact in PET data.

### SUMMARY

Aspects described herein address the above-referenced problems and others. This summary introduces concepts that are described in more detail in the detailed description. It should not be used to identify essential features of the claimed subject matter, nor to limit the scope of the claimed subject matter.

In one aspect, a system includes an attenuation corrector configured to generate Computed Tomography-(CT-) based attenuation correction data from CT image data. The system further includes a Positron Emission Tomography (PET) reconstructor configured to reconstruct first PET image data based on PET projection data and the CT-based attenuation correction data. The system further includes a data attenuation correction artifact mitigator configured to analyze the first PET image data for a presence of attenuation correction artifact. The system further includes an inference engine configured to predict attenuation correction data based on non-attenuation corrected PET image data in response to the presence of attenuation correction artifact in the first PET image data. The system further includes an attenuation correction data updater configured to generate modified attenuation correction data based on the CT-based attenuation correction data and the predicted attenuation correction data. The PET reconstructor is further configured to reconstruct second PET image data based on the PET projection data and the modified attenuation correction data.

In another aspect, a computer-implemented method includes generating CT-based attenuation correction data from CT image data. The computer-implemented method further includes reconstructing first PET image data based on PET projection data and the CT-based attenuation correction data. The computer-implemented method further includes determining whether the first PET image data includes attenuation correction artifact. The computer-implemented method further includes predicting attenuation correction data based on non-attenuation corrected PET image data in response to a presence of attenuation correction artifact in the first PET image data. The computer-implemented method further includes generating modified attenuation correction data based on the CT-based attenuation correction data and the predicted attenuation correction data. The computer-implemented method further includes reconstructing second PET image data based on the PET projection data and the modified attenuation correction data.

In another aspect, a computer system includes a computer readable storage medium with instructions for correcting motion in data and a processor configured to execute the instructions. The instructions cause the processor to generate CT-based attenuation correction data from CT image data. The instructions further cause the processor to reconstruct first PET image data based on PET projection data and the CT-based attenuation correction data. The instructions further cause the processor to determine whether the first PET image data includes attenuation correction artifact. The instructions further cause the processor to predict attenuation correction data based on non-attenuation corrected PET image data in response to a presence of attenuation correction artifact in the first PET image data. The instructions further cause the processor to generate modified attenuation correction data based on the CT-based attenuation correction data and the predicted attenuation correction data. The instructions further cause the processor to reconstruct second PET image data based on the PET projection data and the modified attenuation correction data.

Those skilled in the art will recognize still other aspects of the present application upon reading and understanding the attached description.

### BRIEF DESCRIPTION OF THE DRAWINGS

The application is illustrated by way of example and not limited by the figures of the accompanying drawings in which like references indicate similar elements.

FIG. 1 schematically illustrates a cross-sectional side view of a non-limiting example of an imaging system that includes an attenuation correction artifact mitigator, in accordance with an embodiment(s) herein.

FIG. 2 schematically illustrates a non-limiting example of a PET sub-imaging system of the imaging system, in accordance with an embodiment(s) herein.

FIG. 3 schematically illustrates a non-limiting example of a CT sub-imaging system of the imaging system, in accordance with an embodiment(s) herein.

FIG. 4 schematically illustrates a high level example of the attenuation correction artifact mitigator, in accordance with an embodiment(s) herein.

FIG. 5A schematically illustrates a non-limiting example in which the attenuation correction artifact mitigator is located remote form from the imaging system, in accordance with an embodiment(s) herein.

FIG. 5B schematically illustrates a non-limiting example in which the attenuation correction artifact mitigator is located in memory of an operator console of the imaging system, in accordance with an embodiment(s) herein.

FIG. 6 schematically illustrates a non-limiting example of the attenuation correction artifact mitigator, in accordance with an embodiment(s) herein.

FIG. 7 schematically illustrates a non-limiting example of the attenuation correction artifact mitigator, in accordance with an embodiment(s) herein.

FIG. 8 depicts an image that includes attenuation correction artifact, in accordance with an embodiment(s) herein.

FIG. 9 depicts an image in which the attenuation correction artifact in the image of FIG. 7 is detected, in accordance with an embodiment(s) herein.

FIG. 10 depicts an example NAC PET image, in accordance with an embodiment(s) herein.

FIG. 11 depicts a predicted image from the NAC PET image in FIG. 10 that does not include attenuation correction artifact, in accordance with an embodiment(s) herein.

FIG. 12 depicts a CT-based attenuation correction image used to generate the image in FIG. 7 with the attenuation correction artifact, in accordance with an embodiment(s) herein.

FIG. 13 depicts an updated CT-based attenuation correction image that was updated based on the predicted image in FIG. 9 with no attenuation correction and the artifact CT-based attenuation correction image used to generate the image in FIG. 7 with the attenuation correction artifact, in accordance with an embodiment(s) herein.

FIG. 14 illustrates a limiting example of a flow chart for a computer-implemented method, in accordance with an embodiment(s) herein.

FIG. 15 illustrates another non-limiting example of a flow chart for a computer-implemented method, in accordance with an embodiment(s) herein.

### DETAILED DESCRIPTION

Positron Emission Tomography (PET) is a functional imaging modality that utilizes a radiopharmaceutical that includes a tissue targeted radionuclide (i.e., a radiotracer) to visualize and measure functional processes such as metabolism. Examples of suitable radionuclides include fluorine-18, carbon-11, nitrogen-13, oxygen-15, etc. A non-limiting example of such a radiopharmaceutical includes F-18 fluorodeoxyglucose (FDG), which includes a glucose analog with the positron-emitting radionuclide fluorine-18 substituted for the normal hydroxyl group at the C-2 position in the glucose molecule. The uptake of FDG by tissues is a marker for the tissue uptake of glucose, which is correlated with certain types of tissue metabolism.

For a PET scan, a prescribed radiopharmaceutical dose is first administered to a patient. As the radiopharmaceutical accumulates within organs, vessels, or the like, the radionuclide undergoes positron emission decay and emits positrons. When a positron collides with an electron in the surrounding tissue, both the positron and the electron are annihilated and converted into a pair of photons, or gamma rays, each having an energy of 511 keV. The two photons are directed in substantially opposite directions along a line of response (LOR) and are coincidently detected when they reach respective detectors positioned across from each other on a detector ring assembly, approximately one hundred and eighty degrees apart from each other. The detectors produce PET projection (emission) data indicative thereof.

Prior to being reconstructed, the PET projection undergoes attenuation correction. Attenuation correction compensates for a reduction in signal caused by the tissue attenuation, providing PET projection data that is more accurate and includes quantitative information about radiotracer distribution, which can be employed to assess metabolic activity, aiding in disease diagnosis, staging, and treatment planning. However, attenuation correction data has introduced artifact into PET image data, e.g., due to tissue displacement between the PET and CT acquisitions from respiratory, cardiac, etc. phase mismatch, gross patient motion, etc. For example, respiratory phase mismatch results in under-correction (“banana” artifact) or over-correction of attenuation at the bottom of the lungs.

Described herein is an approach that mitigates attenuation correction artifact. The approach, in general, includes generating non-attenuation corrected (NAC) PET image data, predicting attenuation correction data based on the NAC PET image data, modifying CT-based attenuation data based on the predicted attenuation correction data, attenuation correcting the PET projection data with the modified attenuation data, and reconstructing the attenuation corrected PET projection data to generate PET image data with less to no attenuation correction artifact. This approach performs well for non-ToF scanners, is not susceptible to produce new artifacts in the attenuation correction data, and is patient specific. Generally, the approach can be considered a data-driven patient-specific approach that improves diagnostic confidence of PET data for lesions and their quantitative accuracy for monitoring treatment response and management. In one instance, this approach improves and/or outperforms conventional heuristic approaches.

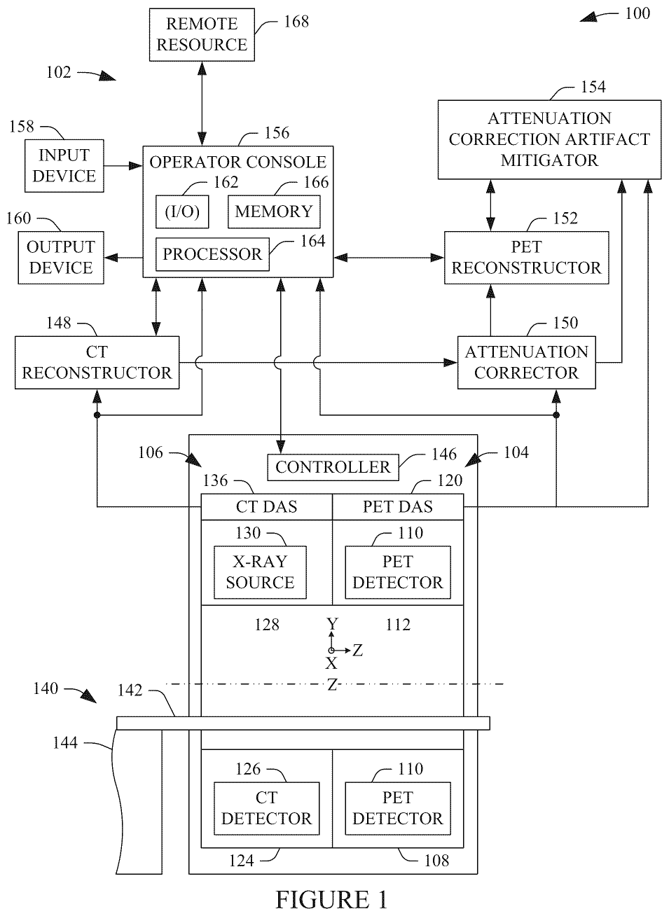

Referring initially with FIG. 1, a system 100 including a cross-sectional side view of a non-limiting example of an imaging system 102 is schematically illustrated. The imaging system 102 includes a Positron Emission Tomography (PET) imaging sub-system 104 and a Computerized Tomography (CT) imaging sub-system 106. In another instance, the PET imaging sub-system 104 and the CT imaging sub-system 106 are separate imaging systems.

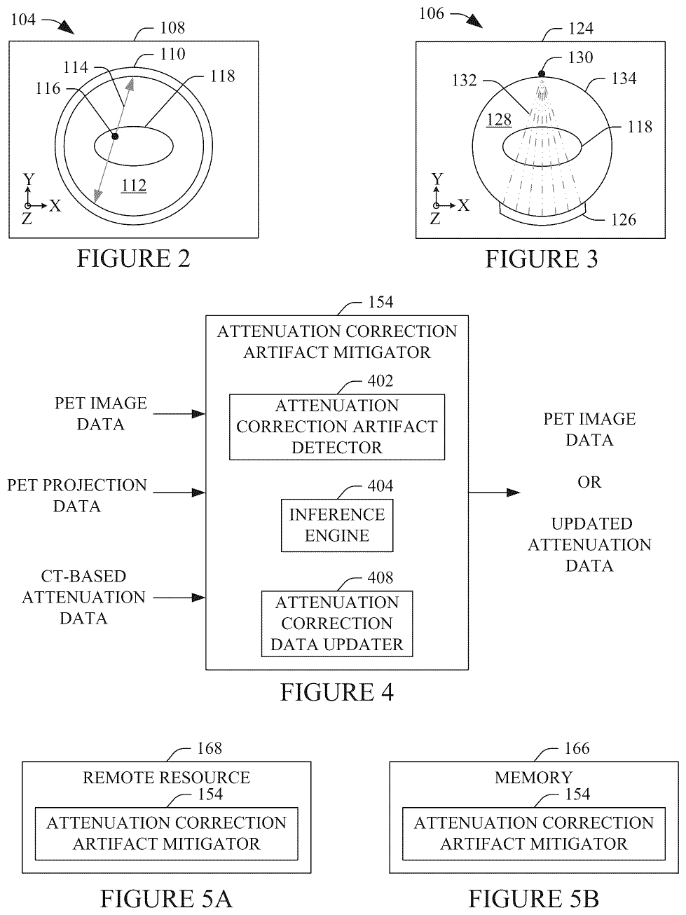

Briefly turning to FIG. 2, a front view of the PET imaging sub-system 104 is schematically illustrated. With reference to FIGS. 1 and 2, the PET imaging sub-system 104 includes a PET gantry 108. The PET gantry 108 includes a radiation sensitive detector array 110 disposed about a PET examination region 112 in a generally annular ring. The radiation sensitive detector array 110 includes a plurality of detectors (photosensors) in optical communication with a scintillator material (scintillation crystals), which is disposed between the plurality of detectors and the PET examination region 112.

The scintillator material converts 511 keV gamma radiation 114 (FIG. 2) produced in response to a positron annihilation event 116 (FIG. 2) occurring in the examination region 112 in a patient 118 (FIG. 2) disposed therein into light photons, and the plurality of detectors convert the light photons into electrical signals. The plurality of detectors includes one or more photosensors, such as avalanche photodiodes, photomultipliers, silicon photomultipliers, and/or another type of photosensor.

The PET imaging sub-system 104 further includes a PET data acquisition system (DAS) 120. The PET data acquisition system 120 receives data from the radiation sensitive detector array 110 and produces PET data, which includes a list of events detected by the plurality of radiation sensitive detectors 110. The PET data acquisition system 120 identifies coincident gamma pairs by identifying events detected in temporal coincidence (or near simultaneously) along a line of response (LOR), which is a straight line joining the two detectors detecting the events, and generates list mode data and/or a histogram (sinogram) indicative thereof.

Coincidence can be determined by a number of factors, including event time markers, which must be within a predetermined time period of each other to indicate coincidence, and the LOR. Events that cannot be paired can be discarded. Events that can be paired are located and recorded as coincidence event pairs. The PET projection data provides information on the LOR for each event, such as a transverse position and a longitudinal position of the LOR and a transverse angle and an azimuthal angle. Additionally, or alternatively, the PET projection data is re-binned into one or more sinograms or projection bins.

Where the PET imaging sub-system 104 is configured for time of flight (TOF), the PET projection data may also include TOF information, which allows a location of an event along a LOR to be estimated. For example, when a positron annihilation event occurs closer to a first detector crystal than a second detector crystal, one annihilation photon may reach the first detector crystal before (e.g., nanoseconds or picoseconds before) the other annihilation photon reaches the second detector crystal. The TOF difference may be used to constrain a location of the positron annihilation event along the LOR.

FIG. 3 schematically illustrates a non-limiting example of a front view of the CT imaging sub-system 106. With reference to FIGS. 1 and 3, the CT imaging sub-system ‘106 includes a CT gantry 124. The CT gantry 124 includes a radiation sensitive detector array 126 disposed about a CT examination region 128 in an annular ring. The CT gantry 124 further includes a radiation source 130, such as an X-ray tube or source, that rotates about the CT examination region 128. The radiation sensitive detector 126 detects radiation 132 (FIG. 3) emitted by the radiation source 130 that has traversed the examination region 128 and the subject 118 (FIG. 3) therein.

The radiation source 130 and the radiation sensitive detector array 126 are disposed on a rotating frame 134 (FIG. 3), opposite each other, across the CT examination region 128. The rotating frame 134 rotates the X-ray source 130 in coordination with the array of X-ray radiation detectors 126. The X-ray source 130 emits the X-ray radiation 132 that traverses the examination region 128 and the subject 118 disposed therein, and the array of X-ray radiation detectors 126 detect X-ray radiation impingent thereon. For each arc segment, the array of X-ray radiation detectors 126 generates a view of projections. A CT data acquisition system (DAS) 136 processes the signals from the CT detector 126 to generate projection data indicative of the radiation attenuation along a plurality of lines or rays through the examination region 128.

Returning to FIG. 1, a subject support 140 includes a tabletop 142 moveably coupled to a frame/base 144. In one instance, the tabletop 142 is slidably coupled to the frame/base 144 via a bearing or the like, and a drive system (not visible) including a controller, a motor, a lead screw, and a nut (or other drive system) translates the tabletop 142 along the frame/base 144 into and out of the examination region 128 and/or 112. The tabletop 142 is configured to support an object or subject in the examination region 128 and/or 112 for loading, scanning, and/or unloading the subject or object. The examination regions 112 and 128 are disposed along a common longitudinal or z-axis (Z). Where the PET and CT sub-systems 104 and 106 are separate imaging systems, each can have its own subject support.

A controller 146 is configured to control components such as rotation of the gantry 134 (FIG. 3), an operation of the X-ray source 130, an operation of the detector arrays 126 and/or 110, an operation of the subject support 140, etc. For example, in one embodiment the controller 146 includes a subject support controller configured to control motion and/or height of the subject support 140 for loading, scanning and/or unloading the subject or object. Where the PET and CT sub-systems 104 and 106 are separate imaging systems, each can have its own controller.

A CT reconstructor 148 reconstructs the CT projection data using reconstruction algorithms to generate volumetric image data (i.e., CT image data) indicative of the radiation attenuation of the subject or object. Suitable reconstruction algorithms include an algebraic reconstruction technique (ART), an analytic image reconstruction algorithm such as filtered backprojection (FBP), etc., an iterative reconstruction algorithm such as advanced statistical iterative reconstruction (ASIR), a maximum likelihood expectation maximization (MLEM) algorithm, etc., another algorithm and/or a combination thereof.

An attenuation corrector 150 generates and applies attenuation correction data (e.g., An attenuation correct (u-) map, etc.) to correct the PET projection data for attenuation (i.e., loss of photons) in the subject or object as the 511 keV coincident photons travel along a LOR to the detector array 110. In one instance, the attenuation correction data is generated based on the CT image data reconstructed by the CT reconstructor, e.g., by scaling CT numbers of the CT image data from a mean CT energy to a PET photon energy of 511 keV. The PET projection data can be processed prior to the energy scaling (e.g., down sample, etc.) and/or after the energy scaling (e.g., resolution matching).

In one instance, the attenuation corrector 150 utilizes a bilinear function that maps a unique 511-keV linear attenuation value in units of inverse centimeters (cm⁻¹) to each measured Hounsfield unit (HU) in the CT image data. The attenuation corrector 150 applies the attenuation correction data to the PET projection data to correct for the tissue attenuation. In general, the attenuation correction process adds counts back into areas that are more attenuated and/or subtracts counts from areas attenuated less than other tissues.

A PET reconstructor 152 reconstructs the attenuation corrected PET projection data using known iterative or other techniques to generate volumetric image data (i.e., PET image data) indicative of the distribution of the radionuclide in a scanned object. Suitable reconstruction algorithms include an ART technique, an analytic image reconstruction algorithm such as FBP, etc., an iterative image reconstruction algorithm such as Ordered Subset Expectation Maximization (OSEM), a block sequential regularized expectation maximization (BSREM) algorithm, etc., another algorithm and/or a combination thereof.

An attenuation correction artifact mitigator 154 corrects for attenuation correction artifact in the PET image data. As described in greater detail below, in one instance the attenuation correction artifact mitigator 154 reconstructs non-attenuation corrected (NAC) PET image data, predicts attenuation correction data based on the NAC PET image data, modifies the CT-based attenuation data generated by the attenuation corrector 150 based on the predicted attenuation correction data, attenuation corrects the PET projection data with the modified CT-based attenuation data, and reconstructs the attenuation corrected PET projection data to generate PET image data with less to no attenuation correction artifact.

Briefly turning to FIG. 4, a nonlimiting example of the attenuation correction artifact mitigator 154 is schematically illustrated. The attenuation correction artifact mitigator 154 receives, as input, at least the PET image data, and, further, the (non-attenuation corrected) PET projection data generated by the PET DAS 120 (FIG. 1) where the CT-based attenuation data will be corrected. The attenuation correction artifact mitigator 154 outputs either the PET image data or updated attenuation correction data.

An attenuation correction artifact detector 402 determines whether to pass the PET image data or invoke the process to correct the CT-based attenuation data. As described in greater detail below, the PET image data is passed where it is determined that the attenuation correction artifact, if any, is below a predetermined threshold level deemed acceptable for quantitative measurements, and the process to correct the CT-based attenuation data is otherwise invoked. In one instance, the attenuation correction artifact detector 402 employs an artificial intelligence (AI) based technique to assess the PET image data for attenuation correction artifact and determine whether to pass the PET image data.

An inference engine 404, in response to invocation of the process to correct the CT-based attenuation data, invokes reconstruction of the non-attenuation corrected PET projection data to generate the NAC PET image data. As described in greater detail below, the inference engine 404 further predicts attenuation correction data based on the NAC PET image data. In one instance, the inference engine 404 employs an AI based technique to predict the attenuation correction data.

An attenuation correction data updater 408 modifies CT-based attenuation data based on the predicted CT attenuation correction data. As described in greater detail below, in one instance this includes registering the CT-based attenuation data to the predicted attenuation correction data while employing affine and/or elastic techniques, and, in another instance, modifies the CT-based attenuation data based on the predicted attenuation correction data under predetermined constraints. Again, the attenuation correction artifact mitigator 154 outputs the modified attenuation data, which is employed to attenuation correct the PET projection data, which is then reconstructed to generate PET image data with less to no attenuation correction artifact.

It is to be appreciated that the attenuation correction artifact mitigator 154 can be integrated, at least in part, into an existing reconstruction pipeline. As discussed in further detail below, the attenuation correction artifact mitigator 154 can be based on artificial intelligence such neural networks, including deep learning neural networks, e.g., to identify attenuation correction artifact and/or create attenuation correction artifact free PET image data, corrected for attenuation and scatter. In addition, compared to other deep learning methods that aim to generate a CT attenuation corrected image data from non-attenuation corrected PET projection data, in one instance, the approach described herein is more reliable and robust, e.g., at least since it does not introduce artifacts and spurious structures in pseudo-CT images that can be a source of other artifacts in PET image data, unlike generative approaches.

Returning to FIG. 1, the imaging system 102 further includes an operator console 156. The operator console 156 includes a computing system such as a computer, a workstation, a server, or the like. The operator console 156 includes an input device 158 such as a keyboard, mouse, touchscreen, microphone, etc., and an output device 160 such as a human readable device such as a display monitor or the like. The operator console 156 further includes input/output (I/O) 162 configured for transmitting and/or receiving signals and/or data, e.g., via the input device 158, output device 160, wireless technology, portable devices, etc.

The operator console 156 further includes a processor 164 such as a central processing unit (CPU), a graphics processing unit (GPU), a micro-processing unit (uPU), etc. The operator console 156 further includes a computer readable storage medium 166 (“MEMORY”), which includes non-transitory medium (e.g., a storage cell, device, etc.) and excludes transitory medium (i.e., signals, carrier waves, and the like). The memory 166 is encoded with computer executable instructions and/or data. Software resident in the memory 166 allows for operating the PET imaging sub-system 104 and the CT imaging sub-system 106.

In one instance, the operator console 156 is configured to receive at least the PET projection data from the PET DAS 120, the CT-based attenuation data from the attenuation corrector 150, the PET image data from the PET reconstructor 152, the modified CT-based attenuation data from the attenuation correction artifact mitigator 154, the CT projection data from CT DAS 136, and/or the CT image data from the CT reconstructor 148. The operator console 156 is further configured to provide data to one or more of the attenuation corrector 150, the PET reconstructor 152, the attenuation correction artifact mitigator 154 and/or the CT reconstructor 148. Where the PET and CT sub-systems 104 and 106 are separate imaging systems, each can have its own operator console.

The system 100 includes a remote resource 168. In one instance, the remote resource 168 includes a radiology information system (RIS), a hospital information system (HIS), an electronic medical record (EMR), a picture archiving and communication system (PACS), a server, a database, a cloud-based resource, etc. The imaging system 102 is in electrical communication with the remote resource 168 and is configured to transmit and/or receive PET projection data, CT projection, CT image data, and/or PET image data to and/or from the remote resource 168, e.g., via Digital Imaging and Communications in Medicine (DICOM) protocol and/or other protocol.

FIGS. 5A and 5B schematically illustrate variations of the imaging system 102.

In FIG. 5A, the attenuation correction artifact mitigator 154 is located in the remote resource 168. For example, at least one of the attenuation correction artifact detector 402, the inference engine 404 and the attenuation correction data updater 408 is located remote from the imaging system 102. In this instance, the remote resource 168 can include a cloud based processing and/or storage resource, a server, a distributed network, etc. In another instance, part of the attenuation correction artifact mitigator 154 is local to the imaging system 102 and part of the attenuation correction artifact mitigator 154 is remoted from the imaging system 102.

In another variation, the attenuation correction artifact mitigator 154 is located in the memory 166 of the operator console 156 (FIG. 1). For example, at least one of the attenuation correction artifact detector 402, the inference engine 404 and the attenuation correction data updater 408 is located in the memory 166 of the operator console 156. In yet another variation, the attenuation correction artifact mitigator 154 is distributed via a combination of FIGS. 1, 5A and/or 5B. For example, a part of the attenuation correction artifact mitigator 154 can be located in the remote resource 168 and at least another part can be located in the memory 166 and/or elsewhere. In another example, a part of the attenuation correction artifact mitigator 154 can be located in the memory 166 and at least another part can be located in the remote resource 168 and/or elsewhere.

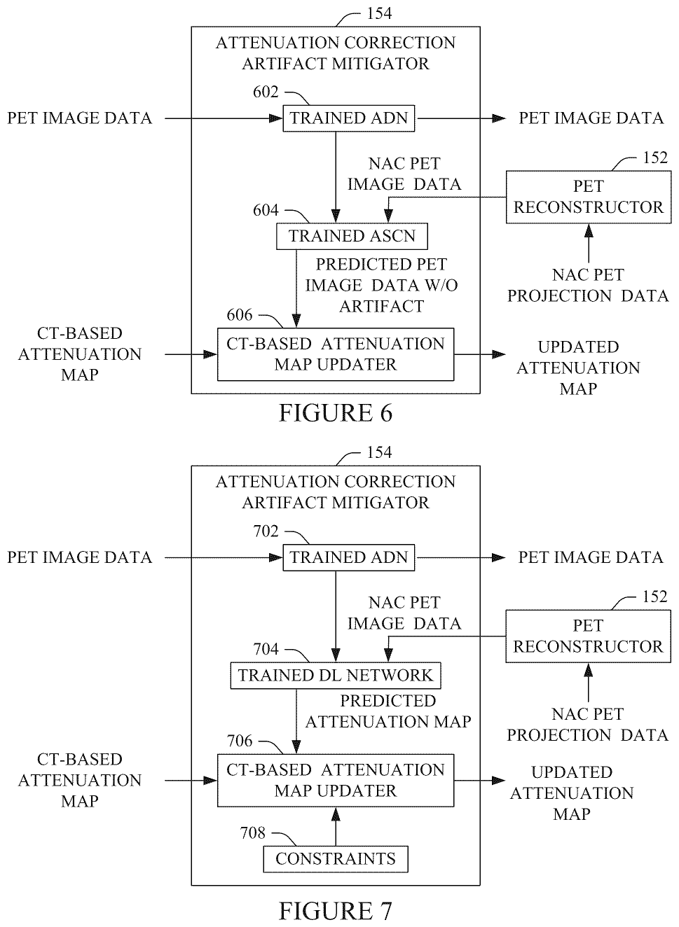

FIGS. 6 and 7 schematically illustrate examples of the attenuation correction artifact mitigator 154. With FIG. 6, the CT-based attenuation data includes a CT-based attenuation map. Likewise, with FIG. 7, the CT-based attenuation data include a CT-based attenuation map. In another example, other CT-based attenuation data is contemplated.

Referring first to FIG. 6, the attenuation correction artifact detector 402 (FIG. 4) includes a trained artifact detection network (ADN) 602, the inference engine 404 (FIG. 4) includes a trained attenuation and scatter network (ASCN) 604, and the attenuation correction data updater 408 (FIG. 4) includes a CT-based attenuation map updater 606. In addition, the attenuation correction artifact mitigator 154 employs the PET reconstructor 152. In another instance, the attenuation correction artifact mitigator 154 includes its own PET reconstructor and/or utilizes another PET reconstructor.

The attenuation correction artifact mitigator 154 receives, as input, the PET image data. The ADN 602 processes the PET image data and determines whether to apply attenuation correction artifact correction. In one instance, the ADN 602 includes a classifier trained to determine whether there are attenuation correction artifacts in the PET image data. Alternatively, or additionally, the ADN 602 includes a trained segmentation network trained to determine whether there are attenuation correction artifact in the PET image data. Other approaches are also contemplated herein.

An example of such a suitable classifier is a deep Convolutional Neural Network (CNN) architecture with multiple layers such as VGG-net, including VGG-16 and VGG-19, which respectively include sixteen (16) and nineteen (19) convolutional layers. An example of such a suitable segmentation network includes a segmentation network that segments the photopenic areas and/or other regions, which can be used to measure a severity of the attenuation correction artifact that is utilized to decide if correction is needed. Such a network can be trained in supervised learning sessions using artifact-labelled datasets with and without attenuation correction artifacts.

Where the attenuation correction artifact mitigator 154 determines attenuation correction artifact correction will not be applied, the PET image data can be output or further processed (e.g., via one or more subsequent reconstructions). Where the attenuation correction artifact mitigator 154 determines attenuation correction artifact correction will be applied, the attenuation correction artifact mitigator 154 invokes the trained ASCN 604. In this instance, the attenuation correction artifact mitigator 154 further receives, as input, the PET projection data and the CT-based attenuation map.

The PET reconstructor 152 reconstructs the PET projection data and generates the NAC PET image data. Again, the attenuation correction artifact mitigator 154 can utilize a different reconstructor, e.g., a reconstructor of the attenuation correction artifact mitigator 154 and/or other reconstructor. The trained ASCN network 604 predicts CT attenuation corrected PET image data based on the NAC PET image data. In one instance, the predicted CT attenuation corrected PET image data resembles CT attenuation corrected PET image data that includes little to no attenuation correction artifact, corrected for both attenuation and scatter.

An example of such a network is a CNN trained in a supervised learning session using many datasets identified as with no attenuation artifacts. For these datasets, CT attenuation corrected PET image data (with or without ToF) is employed as target or label images, and non-attenuation corrected PET image data (with or without ToF) as input image data. A suitable CNN is a DCNN such as a residual U-NET or a similar network modified specifically for non-attenuation corrected PET image data to CT attenuation corrected PET image data conversion. The training datasets, in general, include a large amount of diverse data.

The CT-based attenuation map updater 606 registers the input CT-based attenuation map to the predicted CT attenuation corrected PET image data. In one instance, the registration includes affine or rigid transformation (e.g., linear transformations), which rotates, scales, translates, etc. the CT-based attenuation map to align it with the predicted CT attenuation corrected PET image data. In another instance, the registration includes clastic or nonrigid transformations (e.g., splines, etc.), which further include warping the CT-based attenuation map to align it with the predicted CT attenuation corrected PET image data.

In one instance, the registration mitigates any phase mismatch (e.g., respiratory, cardiac, etc.) between the CT and the PET acquisitions, e.g., by updating the CT-based attenuation map to match the phase of the PET acquisition. The attenuation correction artifact mitigator 154 outputs the updated attenuation map. The updated attenuation map is then used to reconstruct the PET projection data, e.g., as described herein in connection with the PET reconstructor 152 in FIG. 1.

In a variation, the trained ADN 602 is omitted and all PET image data corrected for attenuation correction artifact. In another variation, the PET image data reconstructed using the updated attenuation map is provided as input to the attenuation correction artifact mitigator 154 for a second pass through attenuation correction artifact mitigator 154, which, in one instance, passes the PET image data, and, in another instance, invokes the trained ASCN 604. Iteration stopping criteria may include a predetermined maximum number of iterations, a predetermined maximum allowable time for the correction, a predetermined amount of attenuation correction artifact.

Turning now to FIG. 7, the attenuation correction artifact detector 402 (FIG. 4) includes a trained artifact detection network (ADN) 702, the inference engine 404 (FIG. 4) includes a trained deep-learning (DL) network 704, and the attenuation correction data updater 408 (FIG. 4) includes a CT-based attenuation map updater 706 along with constraints 708. In addition, the attenuation correction artifact mitigator 154 employs the PET reconstructor 152. In another instance, the attenuation correction artifact mitigator 154 includes its own PET reconstructor and/or utilizes another PET reconstructor.

The attenuation correction artifact mitigator 154 receives, as input, the PET image data. The trained ADN 702 processes the PET image data and determines whether to apply attenuation correction artifact correction to the PET image data. Similar to FIG. 2, the ADN 702 includes a classifier trained to determine whether there are artifacts in attenuation corrected PET image data, a trained segmentation network trained to determine whether there are artifacts in attenuation corrected PET image data, and/or other approaches to determine whether there are artifacts in attenuation corrected PET image data.

Where the attenuation correction artifact mitigator 154 determines attenuation correction artifact correction will not be applied, the PET image can be output or further processed (e.g., via one or more subsequent reconstructions). Where the attenuation correction artifact mitigator 154 determines attenuation correction artifact will be applied, the attenuation correction artifact mitigator 154 invokes the trained DL Network 704. In this instance, the attenuation correction artifact mitigator 154 further receives, as input, the PET projection data and the CT-based attenuation map.

The PET reconstructor 152 reconstructs the PET projection data and generates the NAC PET image data. Again, the attenuation correction artifact mitigator 154 can utilize a different reconstructor, e.g., a reconstructor of the attenuation correction artifact mitigator 154 and/or other reconstructor. The trained DL network 704 predicts a PET attenuation map based on the NAC PET image data. In one instance, the DL network 704 is trained to convert NAC PET image data to a CT-based attenuation map in units of inverse centimeters (cm⁻¹) using PET image data with no to minimal attenuation artifacts. An example of a suitable model includes U-Net or transformer-based model.

The CT-based attenuation map updater 706 compares the input CT-based attenuation map to the predicted CT-based attenuation map and modifies the CT-based attenuation map, based on the constraints 708, to compensate for any phase mismatch (e.g., respiratory, cardiac, etc.) between the CT and PET acquisitions. In one instance, the constraints 708 are configurable based on the problem to be solved. In this instance, a user can provide input, e.g., via the input device 158 of the operator console 156 (FIG. 1), that indicates the constraints to utilize for the update. An example constraint indicates that modifications can only be applied to the CT-based attenuation map within a body mask. Another example constraint indicates that modifications can only be applied to correct gross patient motion.

In one instance, the modification mitigates any phase mismatch (e.g., respiratory, cardiac, etc.) between the CT and the PET acquisitions, e.g., by updating the CT-based attenuation map to match the phase of the PET acquisition. The attenuation correction artifact mitigator 154 outputs the updated attenuation map. The updated attenuation map is then used to reconstruct the PET projection data, e.g., as described herein in connection with the PET reconstructor 152 in FIG. 1.

In a variation, the trained ADN 702 is omitted and all PET image data corrected for attenuation correction artifact. In another variation, the PET image data reconstructed using the updated attenuation map is provided as input to the attenuation correction artifact mitigator 154 for a second pass through attenuation correction artifact mitigator 154, which, in one instance, passes the PET image data, and, in another instance, invokes the trained DL network 704. Iteration stopping criteria may include a predetermined maximum number of iterations, a predetermined maximum allowable time for the correction, a predetermined amount of attenuation correction artifact.

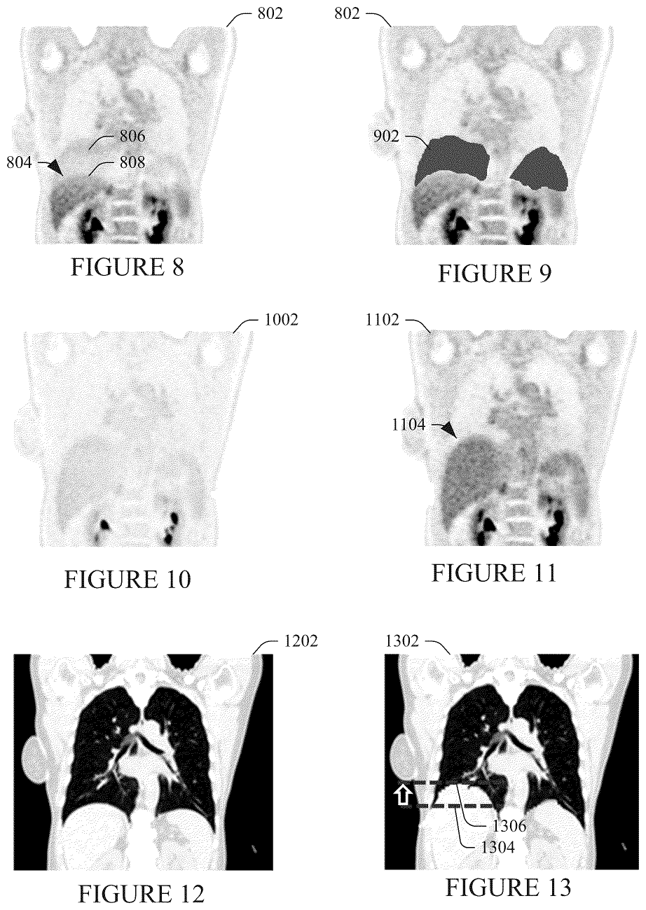

FIGS. 8, 9, 10, 11, 12 and 13 include images corresponding to the image data generated in connection with the example in FIG. 6. The illustrated images are coronal images. In another instance, the images are axial images. In yet another instance, the images are sagittal images. In still another instance, the images are oblique images. In another instance, the images are a combination of coronal, axial, sagittal, oblique and/or other image. In yet another instance, the images are three-dimensional (3-D) images, or volumes.

FIG. 8 depicts an image 802 that includes an attenuation correction artifact 804 resulting from a phase mismatch between the PET and CT acquisitions. The attenuation correction artifact 804 manifests as a first region 806 represented with a first range of gray scale values and a second region 808 represented with a second range of gray scale values, where the first range of gray scale values corresponds to lighter shades of gray and the second range of gray scale values corresponds to darker shades of gray.

FIG. 9 depicts the image 802 with a region 902 corresponding to the attenuation correction artifact highlighted with a gray overlay. The trained ASCN 604 (FIG. 6) identifies a presence of the attenuation correction artifact, as described in connection with FIG. 6 and/or otherwise.

FIG. 10 depicts a NAC PET image data 1002. The NAC PET image data is generated by the PET reconstructor 154 and/or other reconstructor with the non-attenuation corrected PET projection data, as described in connection with FIG. 6 and/or otherwise.

FIG. 11 depicts a predicted PET image data 1102 resembling CT attenuation corrected PET image data that includes little to no attenuation correction artifact, corrected for both attenuation and scatter. The predicted PET image data is generated by the trained ASCN network 604, as described in connection with FIG. 6 and/or otherwise. A region 1104, relative to the regions 806 and 808 (FIG. 8), does not include the attenuation correction artifact 902 (FIG. 9).

FIG. 12 depicts a CT-based attenuation map 1202. FIG. 13 depicts an updated CT-based attenuation map 1302, updated based on the predicted PET image data 1102 (FIG. 11) and the CT-based attenuation map 1202 (FIG. 12). FIG. 13 indicates that the update in this example included warping pixels/voxels located about a first region 1304 to a second region 1306.

The images of FIGS. 8, 9, 10 and 13 also correspond to FIG. 7. Whereas the example of FIG. 6 predicts a PET image that does not include attenuation correction artifact using the trained ASCN 604 and utilizes the PET image to warp and/or otherwise change the input measured CT-based attenuation map, the example of FIG. 7 predicts a new attenuation map for use in updating the input CT-based attenuation map. In other words, the example in FIG. 7 goes directly from the image of FIG. 10 to the image of FIG. 13, without generating the image of FIG. 11 and registering the image of FIG. 11 with the input CT-based attenuation map of FIG. 12 to generate the image of FIG. 13. Again, the image 802 of FIG. 8 show the attenuation correction artifact 804 resulting from a phase mismatch between the PET and CT acquisitions, FIG. 9 shows the region 902 within the image 802 with corresponding to the attenuation correction artifact, FIG. 10 shows the NAC PET image data 1002, and FIG. 13 shows the modified CT-based attenuation map that is utilized for the PET reconstruction to mitigate attenuation correction artifact.

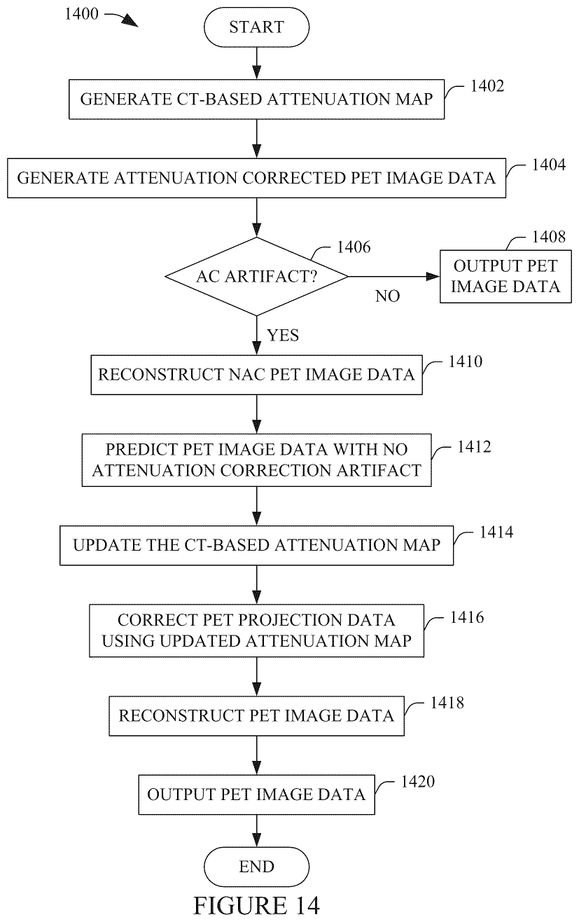

FIG. 14 illustrates a non-limiting example of a flow chart 1400 for a computer-implemented method. It is to be appreciated that the ordering of the acts in the method is not limiting. As such, other orderings are contemplated herein. In addition, one or more acts may be omitted, and/or one or more additional acts may be included.

At 1402, a CT scan is performed generating CT projection data, as described herein and/or otherwise, the CT projection data is reconstructed generating CT image data, and a CT-based attenuation map is generated based on the CT image data, as described herein and/or otherwise. At 1404, a PET scan is performed generating PET projection data, the PET projection data is corrected for attenuation based on the CT-based attenuation map, and the attenuation corrected PET projection data is reconstructed generating PET image data, as described herein and/or otherwise.

At 1406, the PET image data is analyzed for attenuation correction artifact, as described herein and/or otherwise. For example, in one instance the ADN 602 processes the PET image data via a trained classifier, a trained segmentation network, etc. trained to determine whether there is attenuation correction artifact in the PET image data. If attenuation correction artifact is absent, then at 1408 the PET image is output, as described herein and/or otherwise. However, if attenuation correction artifact is present, then at 1410 a NAC PET image data is reconstructed, as described herein and/or otherwise. For example, the PET reconstructor 152 and/or other reconstructor generates NAC PET image data based on the PET projection data.

At 1412, the NAC PET image data is employed to predict PET image data that does not include attenuation correction artifact, as described herein and/or otherwise. For example, where the attenuation correction artifact mitigator 154 determines attenuation correction artifact correction will be applied, the trained ASCN 604 predicts CT attenuation corrected PET image data based on the NAC PET image data, where the predicted CT attenuation corrected PET image data resembles CT attenuation corrected PET image data that includes little to no attenuation correction artifact, corrected for both attenuation and scatter.

At 1414, the CT-based attenuation map is modified based on the predicted PET image data, as described herein and/or otherwise. For example, in one instance the CT-based attenuation map is registered to the predicted CT attenuation corrected PET image data via an affine and/or clastic transformation to align the CT-based attenuation map with the motion phase of the PET acquisition, generating a modified attenuation map corresponding to the motion of the PET acquisition.

At 1416, the PET projection data is corrected for attenuation based on the updated attenuation map, as described herein and/or otherwise. At 1418, the attenuation corrected PET projection data is reconstructed generating PET image data, as described herein and/or otherwise. At 1420, the PET image data is output, as described herein and/or otherwise. For example, the PET image data can be visually displayed, superimposed (overlaid, fused, etc.) with the CT image data, further processed (e.g., one or more reconstructions, etc.), archived, filed, etc.

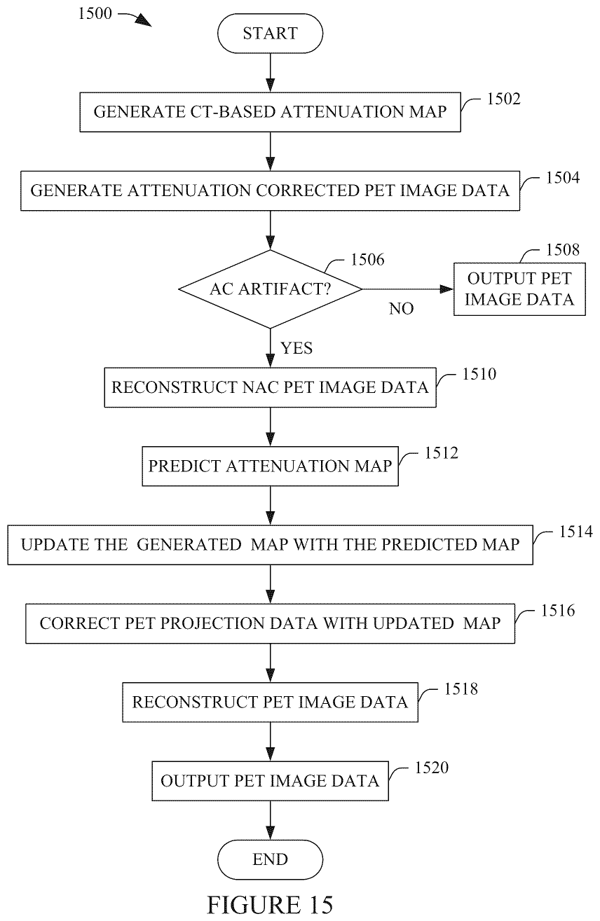

FIG. 15 illustrates a non-limiting example of a flow chart 1500 for a computer-implemented method. It is to be appreciated that the ordering of the acts in the method is not limiting. As such, other orderings are contemplated herein. In addition, one or more acts may be omitted, and/or one or more additional acts may be included.

At 1502, a CT scan is performed generating CT projection data, as described herein and/or otherwise, the CT projection data is reconstructed generating CT image data, and a CT-based attenuation map is generated based on the CT image data, as described herein and/or otherwise. At 1504, a PET scan is performed generating PET projection data, the PET projection data is corrected for attenuation based on the CT-based attenuation map, and the attenuation corrected PET projection data is reconstructed generating PET image data, as described herein and/or otherwise.

At 1506, the PET image data is analyzed for attenuation correction artifact, as described herein and/or otherwise. For example, in one instance the ADN 602 processes the PET image data via a trained classifier, a trained segmentation network, etc. trained to determine whether there is attenuation correction artifact in the PET image data. If attenuation correction artifact is absent, then at 1508 the PET image is output, as described herein and/or otherwise. However, if attenuation correction artifact is present, then at 1410 a NAC PET image data is reconstructed, as described herein and/or otherwise. For example, the PET reconstructor 152 and/or other reconstructor generates NAC PET image data based on the PET projection data.

At 1512, the NAC PET image data is employed to predict an attenuation map, as described herein and/or otherwise. For example, where the attenuation correction artifact mitigator 154 determines attenuation correction artifact correction will be applied, the trained ASCN 604 predicts an attenuation map via the trained DL Network 704, etc. At 1514, the CT-based based attenuation map is modified based on the predicted attenuation map, as described herein and/or otherwise. For example, the CT-based attenuation map updater 706 compares the input CT-based attenuation map to the predicted attenuation map and modifies the CT-based attenuation map, based on the constraints 708 such as modifications only to the CT-based attenuation map within a body mask, modifications only to correct gross patient motion, etc.

In one instance, the modification mitigates any phase mismatch (e.g., respiratory, cardiac, etc.) between the CT and the PET acquisitions, e.g., by updating the CT-based attenuation map to match the phase of the PET acquisition. At 1516, the PET projection data is corrected for attenuation based on the modified attenuation map, as described herein and/or otherwise. At 1518, the attenuation corrected PET projection data is reconstructed generating PET image data, as described herein and/or otherwise. At 1520, the PET image data can be visually displayed, superimposed (overlaid, fused, etc.) with the CT image data, further processed (e.g., one or more reconstructions, etc.), archived, filed, etc.

Again, the approach described herein mitigates attenuation correction artifact. In general, the approach includes generating NAC PET image data, predicting attenuation correction data based on the NAC PET image data, modifying CT-based attenuation data based on the predicted attenuation correction data, attenuation correcting the PET projection data with the modified attenuation data, and reconstructing the attenuation corrected PET projection data to generate PET image data with less to no attenuation correction artifact.

The above can be implemented by way of computer readable instructions, encoded, or embedded on the computer readable storage medium, which, when executed by a computer processor, cause the processor to carry out the described acts or functions. Additionally, or alternatively, at least one of the computer readable instructions is carried out by a signal, carrier wave or other transitory medium, which is not computer readable storage medium.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include such additional elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”. The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present disclosure. That is, features of the described embodiments can be combined with any appropriate aspect described above and optional features of any one aspect can be combined with any other appropriate aspects. Similarly, features set forth in dependent claims can be combined with non-mutually exclusive features of other dependent claims, particularly where the dependent claims depend on the same independent claim. Single claim dependencies may have been used as practice in some jurisdictions that require them, but this should not be taken to mean that the features in the dependent claims are mutually exclusive.

What is claimed is:

1. A system, comprising:
an attenuation corrector configured to generate Computed Tomography-(CT-) based attenuation correction data from CT image data;
a Positron Emission Tomography (PET) reconstructor configured to reconstruct first PET image data based on PET projection data and the CT-based attenuation correction data;
an attenuation correction artifact mitigator configured to analyze the first PET image data for a presence of attenuation correction artifact;
an inference engine configured to predict attenuation correction data based on non-attenuation corrected PET image data in response to the presence of attenuation correction artifact in the first PET image data; and
an attenuation correction data updater configured to generate modified attenuation correction data based on the CT-based attenuation correction data and the predicted attenuation correction data;
wherein the PET reconstructor is further configured to reconstruct second PET image data based on the PET projection data and the modified attenuation correction data.

2. The system of claim 1, wherein the attenuation correction artifact mitigator employs a trained network to identify attenuation correction artifact in PET image data sets.

3. The system of claim 2, wherein the trained network includes a trained classifier.

4. The system of claim 2, wherein the trained network includes a trained segmentation network.

5. The system of claim 1, wherein the inference engine invokes reconstruction of non-attenuation corrected PET image data and non-attenuation corrected PET projection data.

6. The system of claim 5, wherein the CT-based attenuation correction data includes a CT-based attenuation map, and the inference engine includes a trained attenuation and scatter network configured to predict PET image data that does not include attenuation correction artifact based on the non-attenuation corrected PET image data.

7. The system of claim 6, wherein the attenuation correction data updater is further configured to register CT-based attenuation correction data to the predicted PET image data to generate the modified attenuation correction data.

8. The system of claim 5, wherein the CT-based attenuation correction data includes a CT-based attenuation map, and the inference engine includes a trained deep learning network configured to predict an attenuation map based on the non-attenuation corrected PET image data.

9. The system of claim 8, wherein the attenuation correction data updater is further configured to modify the CT-based attenuation map based on the predicted attenuation map to generate the modified attenuation correction data.

10. The system of claim 9, wherein the attenuation correction data updater is further configured to modify the CT-based attenuation map based on one or more user selectable constraints.

11. A computer-implemented method, comprising:
generating CT-based attenuation correction data from CT image data;
reconstructing first PET image data based on PET projection data and the CT-based attenuation correction data;
determining whether the first PET image data includes attenuation correction artifact;
predicting attenuation correction data based on non-attenuation corrected PET image data in response to a presence of attenuation correction artifact in the first PET image data;
generating modified attenuation correction data based on the CT-based attenuation correction data and the predicted attenuation correction data; and
reconstructing second PET image data based on the PET projection data and the modified attenuation correction data.

12. The computer-implemented method of claim 11, wherein the CT-based attenuation correction data includes a CT-based attenuation map, and the predicting of the attenuation correction data includes invoking reconstruction of non-attenuation corrected PET image data from non-attenuation corrected PET projection data and predicting PET image data that does not include attenuation correction artifact based on the non-attenuation corrected PET image data.

13. The computer-implemented method of claim 12, wherein the generating the modified attenuation correction data includes registering the CT-based attenuation map to the predicted PET image data.

14. The computer-implemented method of claim 11, wherein the CT-based attenuation correction data includes a CT-based attenuation map, and the predicting of the attenuation correction data includes invoking reconstruction of non-attenuation corrected PET image data from non-attenuation corrected PET projection data and predicting the attenuation correction data based on the non-attenuation corrected PET image data.

15. The computer-implemented method of claim 14, wherein the attenuation correction data updater is further configured to modify the CT-based attenuation map based on the predicted attenuation correction data to generate the modified attenuation correction data.

16. A computer readable storage medium encoded with computer executable instructions, which when executed by a processor, causes the processor to:
generate CT-based attenuation correction data from CT image data;
reconstruct first PET image data based on PET projection data and the CT-based attenuation correction data;
determine whether the first PET image data includes attenuation correction artifact;
predict attenuation correction data based on non-attenuation corrected PET image data in response to a presence of attenuation correction artifact in the first PET image data;
generate modified attenuation correction data based on the CT-based attenuation correction data and the predicted attenuation correction data; and
reconstruct second PET image data based on the PET projection data and the modified attenuation correction data.

17. The computer readable storage medium of claim 16, wherein the CT-based attenuation correction data includes a CT-based attenuation map, and the predicting of the attenuation correction data includes invoking reconstruction of non-attenuation corrected PET image data from non-attenuation corrected PET projection data and predicting PET image data that does not include attenuation correction artifact based on the non-attenuation corrected PET image data.

18. The computer readable storage medium of claim 17, wherein the generating the modified attenuation correction data includes registering the CT-based attenuation map to the predicted PET image data.

19. The computer-implemented method of claim 16, wherein the CT-based attenuation correction data includes a CT-based attenuation map, and the predicting of the attenuation correction data includes invoking reconstruction of non-attenuation corrected PET image data from non-attenuation corrected PET projection data and predicting a attenuation map based on the non-attenuation corrected PET image data.

20. The computer-implemented method of claim 19, wherein the attenuation correction data updater is further configured to modify the CT-based attenuation map based on the predicted attenuation map to generate the modified attenuation correction data.
